(19) United States
(12) Patent Application Publication
(10) Pub. No.: US 2026/0095631 A1
(43) Pub. Date: Apr. 2, 2026

(54) DISPLAY DEVICE AND OPERATING METHOD THEREOF

(71) Applicant: LG ELECTRONICS INC., Seoul (KR)

(72) Inventors: Youngjun KIM, Seoul (KR); Wanseok OH, Seoul (KR)

(73) Assignee: LG ELECTRONICS INC., Seoul (KR)

(21) Appl. No.: 19/112,530

(22) PCT Filed: Sep. 16, 2022
(86) PCT No.: PCT/KR2022/013892

§ 371 Date: Mar. 17, 2025

(51) Int. Cl. H04N 21/482; H04N 21/422; H04N 21/431

(52) U.S. Cl. CPC H04N 21/482; H04N 21/42204; H04N 21/4312

(57) ABSTRACT

A display device and an operation method therefor are disclosed. The display device, according to at least one embodiment among various embodiments of the present disclosure, comprises a display, a memory, and a processor for exchanging data for communicating with the memory, wherein the processor forms an input list comprising areas allocated for the respective inputs, and outputs the list on a screen, while controlling to play back data received via an input mapped to at least one area among the areas included on the input list and determined according to a predefined order.

### TECHNICAL FIELD

The present disclosure relates to a display device and an operating method thereof.

### BACKGROUND TECHNOLOGY

Recently, the functions of terminals have been diversified, for example, data and voice communication, taking pictures and videos using a camera, recording voice, playing music files using a speaker system, and outputting images or videos to a display.

Some terminals have an added electronic game play function or perform a multimedia player function.

As the functions of such terminals have diversified, they are being implemented in the form of multimedia players with complex functions such as taking pictures or videos, playing music or video files, playing games, and receiving broadcasts.

Conventionally, display devices equipped with large displays such as TVs were generally used by being fixed to a wall or a separate stand.

However, recently, various devices equipped with small displays are often connected or paired through the input port of the display device to use a large display, but the display device has difficulty in providing relevant information or processing relevant operations appropriately due to resource constraints, etc., so that users have experienced inconveniences in using the display device.

### DETAILED DESCRIPTION OF THE INVENTION

### Technical Problem

The present disclosure provides information for identification and convenience of use for various inputs that can be serviced through a display device.

The present disclosure enables easy identification and use of data that can be provided through a corresponding input, even for inactive inputs.

The present disclosure provides customized services by referring to user input or various conditions.

### Technical Solution

A display device according to at least one embodiment of the present disclosure may comprise a display; a memory; and a processor configured to transmit and receive data to and from the memory, wherein the processor is configured to configure an input list including areas allocated for the respective inputs and output the input list on a screen, and wherein the processor is configured to control data received through an input mapped to at least one area among the areas included in the input list determined according to a predefined order to be reproduced.

According to a display device according to at least one embodiment of the various embodiments of the present disclosure, the processor can be configured to control, for areas other than the at least one area determined according to the predefined order, a still image of data to be received and reproduced through an input mapped to the corresponding area or a representative image representing the corresponding input to be provided.

According to a display device according to at least one embodiment of the various embodiments of the present disclosure, the processor can be configured to receive a user input from a connected terminal.

According to a display device according to at least one embodiment of the various embodiments of the present disclosure, the terminal may include at least one of a remote control, an artificial intelligence speaker, and a mobile device.

According to a display device according to at least one embodiment of the various embodiments of the present disclosure, the processor can be configured to control the input list to configured when the user input is an input list request or an erroneous input unrelated to the content being output through the display.

According to a display device according to at least one embodiment of the various embodiments of the present disclosure, the processor can be configured to determine whether a first condition indicating whether a user input has been received or whether a predefined time has elapsed has been satisfied.

According to a display device according to at least one embodiment of the various embodiments of the present disclosure, the processor can be configured to control to provide data received through an input in which video data is mapped to the next area in the predefined order among the areas included in the input list when the first condition has been satisfied.

According to a display device according to at least one embodiment of the various embodiments of the present disclosure, when providing data received through input mapped to the next area according to the satisfaction of the first condition, the processor can be configured to control, for the previous order area, at least one of a first frame of data provided, a last frame, a representative thumbnail image of the corresponding data, a representative thumbnail image representing the input mapped to the corresponding area, and a still image for a scene where the user input was made for the corresponding area to be output.

According to a display device according to at least one embodiment of the various embodiments of the present disclosure, the processor can be configured to configure the input list so that no area is allocated for a deactivated input.

According to a display device according to at least one embodiment of the various embodiments of the present disclosure, the processor can be configured to configure the input list by allocating an area even for a deactivated input, and when it is the turn to provide data to the area for the deactivated input, control to transmit a control signal so that the power of the device connected to the deactivated input is turned on.

According to a display device according to at least one embodiment of the various embodiments of the present disclosure, the processor can be configured to control to transmit the control signal using the HDMI-CEC protocol.

According to a display device according to at least one embodiment of the various embodiments of the present disclosure, the processor can be configured to determine whether a second condition regarding whether data has been provided in order in all allocated areas is satisfied.

According to a display device according to at least one embodiment of the various embodiments of the present disclosure, when the second condition has been satisfied, the processor can be configured to control one of a black screen and a content screen previously provided before the user input to be provided on the screen.

A display device according to at least one embodiment of the various embodiments of the present disclosure may comprise a display; a memory; and a processor configured to transmit and receive data to and from the memory, wherein the processor is configured to through an input list including areas allocated for the respective inputs, wherein the processor is configured to control data received through an input mapped to at least one area among the areas included in the input list determined according to a predefined order, through at least one view screen area of a full screen or multi-view mode to be reproduced.

A method of controlling an operation of a display device according to at least one of the various embodiments of the present disclosure may comprise receiving a user input; and configuring an input list including areas allocated for the respective inputs according to the user input, wherein: (a) the input list is included and output within a dashboard menu, and data received through an input mapped to only at least one area according to a predefined order is reproduced, or (b) data received through an input mapped to at least one area among the areas included in the input list according to a predefined order is reproduced on at least one view screen area of a full screen or multi-view mode.

### Effect of the Invention

According to at least one of the various embodiments of the present disclosure, by configuring and providing an input list including various external inputs including a tuner, there is an effect of providing a service so that data that can be provided through each input can be easily identified and used.

According to at least one of the various embodiments of the present disclosure, there is an effect of providing a service so that data that can be provided through each input can be easily identified and used by temporarily activating a deactivated input through the provided input list.

According to at least one of the various embodiments of the present disclosure, there is an effect of improving the convenience of use for the user by configuring and providing a customized input list by referring to the user's input or various conditions.

### BRIEF DESCRIPTION OF THE DRAWINGS

FIG. 1 is a block diagram illustrating a configuration of a display device according to an embodiment of the present disclosure.

FIG. 2 is a block diagram of a remote control device according to an embodiment of the present disclosure.

FIG. 3 illustrates an actual configuration example of a remote control device according to an embodiment of the present disclosure.

FIG. 4 illustrates an example of utilizing a remote control device according to an embodiment of the present invention.

FIG. 5a and FIG. 5b are diagrams for explaining a horizontal mode and a vertical mode of a stand-type display device according to an embodiment of the present disclosure.

FIG. 6 is a block diagram of a display device according to another embodiment of the present disclosure.

FIG. 7 is a flowchart illustrating an operating method of a display device according to an embodiment of the present disclosure.

FIG. 8 is a diagram illustrating a user interface related to the operation of a display device according to FIG. 7.

FIG. 9 is a flowchart illustrating an operating method of a display device according to another embodiment of the present disclosure.

FIG. 10 is a diagram illustrating a user interface related to the operation of a display device according to FIG. 9.

FIG. 11 is a flowchart illustrating an operating method of a display device according to another embodiment of the present disclosure.

FIG. 12 is a drawing illustrating a user interface related to the operation of the display device according to FIG. 11.

FIG. 13 is a flowchart illustrating a method of operating a display device according to another embodiment of the present disclosure.

FIG. 14 is a drawing illustrating a user interface related to the operation of the display device according to FIG. 13.

FIG. 15 is a drawing illustrating another user interface related to the operation of the display device according to the present disclosure.

FIG. 16 is a drawing illustrating a video data processing operation corresponding to an input port in a display device according to an embodiment of the present disclosure.

### BEST MODE

Hereinafter, embodiments related to the present invention will be described in more detail with reference to the drawings. The suffixes “module” and “part” used for components in the following description are given or used interchangeably only for the convenience of writing the specification, and do not have distinct meanings or roles in themselves.

The display device according to the embodiment of the present invention is, for example, an intelligent display device that adds a computer support function to the broadcast reception function, and while remaining faithful to the broadcast reception function, it can have an interface that is more convenient to use, such as a manual input device, a touch screen, or a space remote control, by adding an Internet function, etc., and can also perform functions such as email, web browsing, banking, or games by connecting to the Internet and a computer with the support of a wired or wireless Internet function. A standardized general-purpose OS (Operating System) can be used for these various functions.

Therefore, the display device described in the present invention can perform various user-friendly functions, for example, since various applications can be freely added or deleted on a general-purpose OS kernel. The display device can be, more specifically, a network TV, an HBBTV, a smart TV, an LED TV, an OLED TV, etc., and can also be applied to a smartphone in some cases.

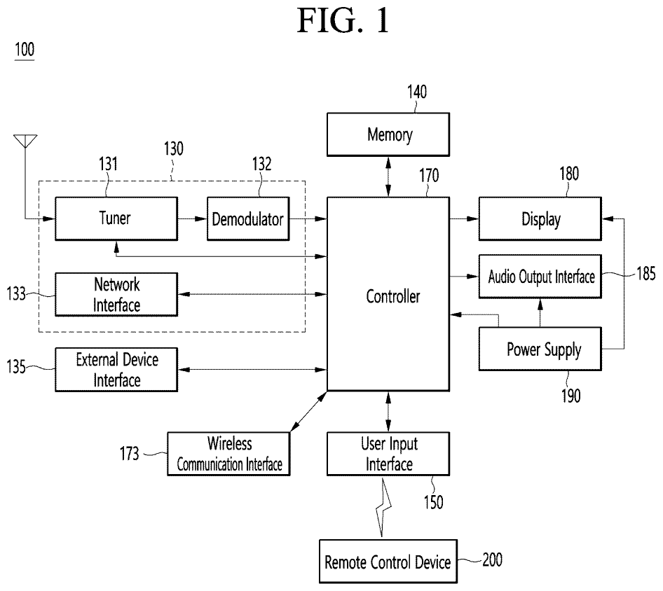

FIG. 1 is a block diagram illustrating the configuration of a display device according to one embodiment of the present invention.

Referring to FIG. 1, the display device 100 may include a broadcast receiving unit 130, an external device interface 135, a memory 140, a user input interface 150, a controller 170, a wireless communication interface 173, a display 180, a speaker 185, and a power supply circuit 190.

The broadcast receiving unit 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into a video signal, an audio signal, and a data signal related to a broadcast program, and may restore the separated video signal, audio signal, and data signal into a form that can be output.

The external device interface 135 can receive an application or an application list in an adjacent external device and transmit it to the controller 170 or memory 140.

The external device interface 135 can provide a connection path between the display device 100 and the external device. The external device interface 135 can receive one or more of images and audio output from an external device connected wirelessly or wiredly to the display device 100 and transmit it to the controller 170. The external device interface 135 can include a plurality of external input terminals. The plurality of external input terminals can include an RGB terminal, one or more HDMI (High Definition Multimedia Interface) terminals, and a component terminal.

The image signal of the external device input through the external device interface 135 can be output through the display 180. The audio signal of the external device input through the external device interface 135 can be output through the speaker 185.

An external device that can be connected to the external device interface 135 may be one of a set-top box, a Blu-ray player, a DVD player, a game console, a sound bar, a smartphone, a PC, a USB memory, and a home theater, but this is only an example.

The network interface 133 may provide an interface for connecting the display device 100 to a wired/wireless network including the Internet. The network interface 133 may transmit or receive data to or from another user or another electronic device through the connected network or another network linked to the connected network.

In addition, some content data stored in the display device 100 may be transmitted to a selected user or electronic device among other users or other electronic devices pre-registered in the display device 100.

The network interface 133 may access a predetermined web page through the connected network or another network linked to the connected network. That is, by accessing a given web page through a network, data can be transmitted or received with the server.

In addition, the network interface 133 can receive content or data provided by a content provider or a network operator. That is, the network interface 133 can receive content such as movies, advertisements, games, VOD, broadcast signals, etc. and information related thereto provided from a content provider or a network provider through a network.

In addition, the network interface 133 can receive update information and update files of firmware provided by a network operator, and can transmit data to the Internet or a content provider or a network operator.

The network interface 133 can select and receive a desired application from among applications open to the public through a network.

The memory 140 can store programs for each signal processing and control within the controller 170, and can store signal-processed images, voices, or data signals.

In addition, the memory 140 may perform a function for temporary storage of video, audio, or data signals input from an external device interface 135 or a network interface 133, and may store information about a given image through a channel memory function.

The memory 140 may store an application or an application list input from an external device interface 135 or a network interface 133.

The display device 100 may reproduce content files (video files, still image files, music files, document files, application files, etc.) stored in the memory 140 and provide them to the user.

The user input interface 150 may transmit a signal input by the user to the controller 170, or transmit a signal from the controller 170 to the user. For example, the user input interface 150 may receive and process control signals such as power on/off, channel selection, and screen settings from the remote control device 200 according to various communication methods such as Bluetooth™, Ultra Wideband (UWB), ZigBee, Radio Frequency (RF) communication, or IR communication, or may transmit control signals from the controller 170 to the remote control device 200.

In addition, the user input interface 150 may transmit control signals input from local keys (not shown) such as power keys, channel keys, volume keys, and settings to the controller 170.

The image signal processed by the controller 170 can be input to the display 180 and displayed as an image corresponding to the image signal. In addition, the image signal processed by the controller 170 can be input to an external output device through the external device interface 135.

The audio signal processed by the controller 170 can be output as audio to the speaker 185. In addition, the audio signal processed by the controller 170 can be input to an external output device through the external device interface 135.

In addition, the controller 170 can control the overall operation within the display device 100.

In addition, the controller 170 can control the display device 100 by a user command or an internal program input through the user input interface 150, and can connect to a network to allow the user to download a desired application or application list into the display device 100.

The controller 170 enables the user-selected channel information, etc. to be output through the display 180 or speaker 185 together with the processed image or audio signal.

In addition, the controller 170 enables the image signal or audio signal from an external device, such as a camera or camcorder, input through the external device interface 135 according to the external device image playback command received through the user input interface 150 to be output through the display 180 or speaker 185.

Meanwhile, the controller 170 can control the display 180 to display an image, and for example, the controller can control the display 180 to display a broadcast image input through the tuner 131, an external input image input through the external device interface 135, an image input through the network interface, or an image stored in the memory 140. In this case, the image displayed on the display 180 may be a still image or a moving image, and may be a 2D image or a 3D image.

In addition, the controller 170 may control the content stored in the display device 100, or the received broadcast content, or the external input content input from the outside to be played, and the content may be in various forms such as a broadcast image, an external input image, an audio file, a still image, a connected web screen, a document file, etc.

The wireless communication interface 173 may perform communication with an external device through wired or wireless communication. The wireless communication interface 173 may perform short range communication with an external device. To this end, the wireless communication interface 173 may support short-range communication using at least one of Bluetooth™ Radio Frequency Identification (RFID), Infrared Data Association (IrDA), UWB, ZigBee, Near Field Communication (NFC), Wireless-Fidelity (Wi-Fi), Wi-Fi Direct, and Wireless Universal Serial Bus (USB) technologies. The wireless communication interface 173 may support wireless communication between the display device 100 and a wireless communication system, between the display device 100 and another display device 100, or between the display device 100 and a network where the display device (100, or an external server) is located through short-range wireless communication networks (Wireless Area Networks). The short-range wireless communication networks may be short-range wireless personal area networks (Wireless Personal Area Networks).

Here, the other display device 100 may be a wearable device (e.g., a smart watch, smart glass, head mounted display (HMD)) or a mobile terminal such as a smart phone that can exchange data with the display device 100 according to the present invention (or can be linked). The wireless communication interface 173 may detect (or recognize) a wearable device capable of communication around the display device 100.

Furthermore, if the detected wearable device is a device authenticated to communicate with the display device 100 according to the present invention, the controller 170 may transmit at least a part of the data processed in the display device 100 to the wearable device through the wireless communication interface 173. Therefore, the user of the wearable device may use the data processed in the display device 100 through the wearable device.

The display 180 can convert the image signal, data signal, OSD signal processed by the controller 170 or the image signal, data signal, etc. received from the external device interface 135 into R, G, B signals, respectively, to generate a driving signal.

Meanwhile, the display device 100 illustrated in FIG. 1 is only an embodiment of the present invention. Some of the illustrated components may be integrated, added, or omitted according to the specifications of the display device 100 actually implemented.

That is, two or more components may be combined into one component, or one component may be subdivided into two or more components, as needed. In addition, the functions performed by each block are for explaining an embodiment of the present invention, and the specific operations or devices thereof do not limit the scope of the rights of the present invention.

According to another embodiment of the present invention, the display device 100 may receive and play back images through a network interface 133 or an external device interface 135 without having a tuner 131 and a demodulator 132 as shown in FIG. 1.

For example, the display device 100 may be implemented separately as an image processing device, such as a set-top box, for receiving contents according to broadcast signals or various network services, and a content reproducing device for playing back contents input from the image processing device.

In this case, the operation method of the display device according to the embodiment of the present invention described below may be performed by any one of the image processing device, such as the separated set-top box, or the content reproducing device having a display 180 and an audio output unit 185, as well as the display device 100 described with reference to FIG. 1.

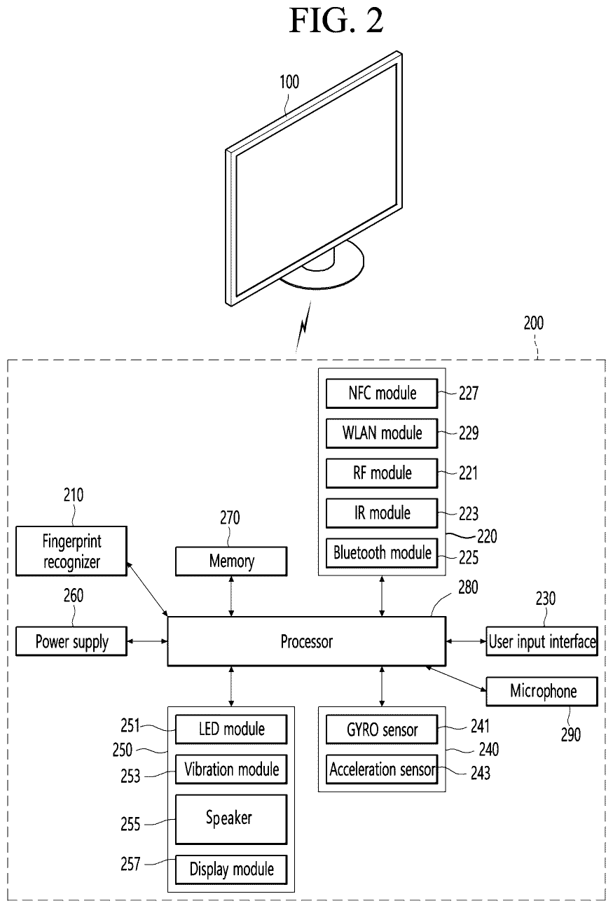

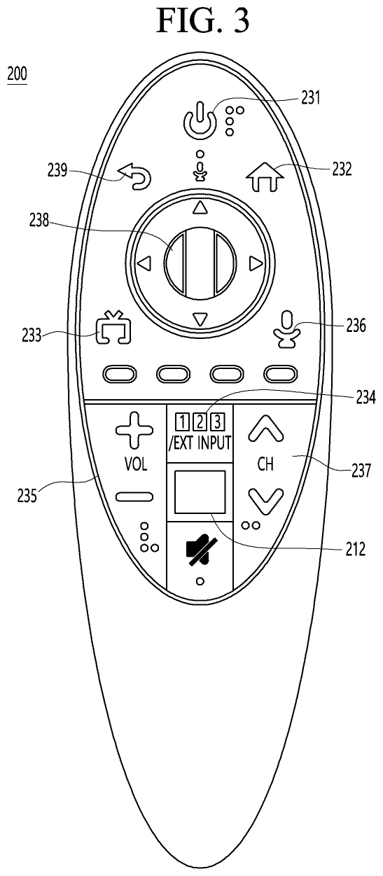

Next, with reference to FIGS. 2 and 3, a remote control device according to an embodiment of the present invention will be described.

FIG. 2 is a block diagram of a remote control device 200 according to an embodiment of the present invention, and FIG. 3 illustrates an example of an actual configuration of a remote control device 200 according to an embodiment of the present invention.

First, with reference to FIG. 2, the remote control device 200 may include a fingerprint recognition device 210, a wireless communication circuit 220, a user input interface 230, a sensor 240, an output interface 250, a power supply circuit 260, a memory 270, a controller 280, and a microphone 290.

With reference to FIG. 2, the wireless communication circuit 220 transmits and receives signals with any one of the display devices 100 according to the embodiments of the present invention described above.

The remote control device 200 may be equipped with an RF circuit 221 capable of transmitting/receiving signals with the display device 100 according to RF communication standards, and an IR circuit 223 capable of transmitting/receiving signals with the display device 100 according to IR communication standards. In addition, the remote control device 200 may be equipped with a Bluetooth circuit 225 capable of transmitting/receiving signals with the display device 100 according to Bluetooth communication standards. In addition, the remote control device 200 may be equipped with an NFC circuit 227 capable of transmitting/receiving signals with the display device 100 according to Near Field Communication (NFC) communication standards, and a WLAN circuit 229 capable of transmitting/receiving signals with the display device 100 according to Wireless LAN (WLAN) communication standards.

In addition, the remote control device 200 transmits a signal containing information about the movement of the remote control device 200 to the display device 100 through the wireless communication circuit 220.

Meanwhile, the remote control device 200 can receive a signal transmitted by the display device 100 through the RF circuit 221, and, if necessary, can transmit commands for power on/off, channel change, volume change, etc. to the display device 100 through the IR circuit 223.

The user input interface 230 can be composed of a keypad, a button, a touch pad, or a touch screen. The user can input a command related to the display device 100 to the remote control device 200 by operating the user input interface 230. If the user input interface 230 is equipped with a hard key button, the user can input a command related to the display device 100 to the remote control device 200 through a push operation of the hard key button. This is explained with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, a confirmation button 238, and a back button 239.

The fingerprint recognition button 212 may be a button for recognizing a user's fingerprint. In one embodiment, the fingerprint recognition button 212 may be capable of a push operation, and may receive a push operation and a fingerprint recognition operation.

The power button 231 may be a button for turning the display device 100 on/off.

The home button 232 may be a button for moving to the home screen of the display device 100.

The live button 233 may be a button for displaying a real-time broadcast program.

The external input button 234 may be a button for receiving an external input connected to the display device 100.

The volume control button 235 may be a button for adjusting the size of the volume output by the display device 100.

The voice recognition button 236 may be a button for receiving a user's voice and recognizing the received voice.

The channel change button 237 may be a button for receiving a broadcast signal of a specific broadcast channel.

The confirmation button 238 may be a button for selecting a specific function, and the back button 239 may be a button for returning to the previous screen.

FIG. 2 will be described again.

If the user input interface 230 has a touch screen, the user can input a command related to the display device 100 to the remote control device 200 by touching the soft key of the touch screen. In addition, the user input interface 230 can have various types of input means that the user can operate, such as a scroll key or a jog key, and this embodiment does not limit the scope of the rights of the present disclosure.

The sensor 240 can have a gyro sensor 241 or an acceleration sensor 243, and the gyro sensor 241 can sense information about the movement of the remote control device 200.

For example, the gyro sensor 241 can sense information about the operation of the remote control device 200 based on the x, y, and z axes, and the acceleration sensor 243 can sense information about the movement speed of the remote control device 200. Meanwhile, the remote control device 200 may further be equipped with a distance measuring sensor, so as to sense the distance to the display 180 of the display device 100.

The output interface 250 may output a video or audio signal corresponding to the operation of the user input interface 230 or the signal transmitted from the display device 100.

The user may recognize whether the user input interface 230 is being operated or whether the display device 100 is being controlled through the output interface 250.

For example, the output interface 250 may be equipped with an LED 251 that lights up when the user input interface 230 is operated or a signal is transmitted and received with the display device 100 through the wireless communication unit 225, a vibrator 253 that generates vibration, a speaker 255 that outputs sound, or a display 257 that outputs an image.

In addition, the power supply circuit 260 supplies power to the remote control device 200, and power waste can be reduced by stopping the power supply when the remote control device 200 does not move for a predetermined period of time.

The power supply circuit 260 can resume the power supply when a predetermined key provided in the remote control device 200 is operated.

The memory 270 can store various types of programs, application data, etc. required for the control or operation of the remote control device 200.

When the remote control device 200 wirelessly transmits and receives signals through the display device 100 and the RF circuit 221, the remote control device 200 and the display device 100 transmit and receive signals through a predetermined frequency band.

The controller 280 of the remote control device can store and refer to information about the frequency band that can wirelessly transmit and receive signals with the display device 100 paired with the remote control device 200 in the memory 270.

The controller 280 controls all matters related to the control of the remote control device 200. The controller 280 can transmit a signal corresponding to a predetermined key operation of the user input interface 230 or a signal corresponding to the movement of the remote control device 200 sensed by the sensor 240 to the display device 100 through the wireless communication unit 225.

In addition, the microphone 290 of the remote control device 200 can acquire voice.

A plurality of microphones 290 can be provided.

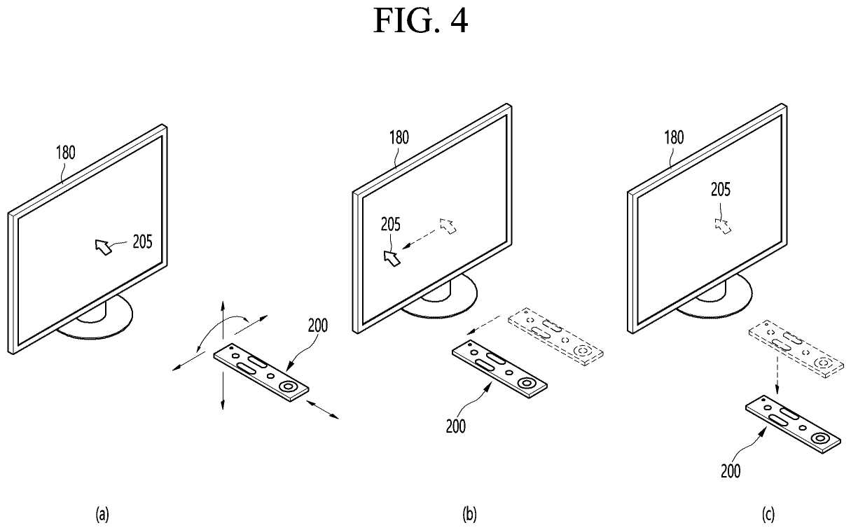

Next, FIG. 4 is described.

FIG. 4 illustrates an example of utilizing a remote control device 200 according to an embodiment of the present invention.

FIG. 4(a) illustrates that a pointer 205 corresponding to a remote control device 200 is displayed on a display 180.

A user can move or rotate the remote control device 200 up and down, left and right. The pointer 205 displayed on the display 180 of the display device 100 corresponds to the movement of the remote control device 200. As shown in the drawing, this remote control device 200 can be named a ‘space remote control’ because the pointer 205 moves and is displayed according to the movement in 3D space.

FIG. 4(b) exemplifies that when a user moves the remote control device 200 to the left, the pointer 205 displayed on the display 180 of the display device 100 also moves to the left in response.

Information about the movement of the remote control device 200 detected by the sensor of the remote control device 200 is transmitted to the display device 100. The display device 100 can calculate the coordinates of the pointer 205 from the information about the movement of the remote control device 200. The display device 100 can display the pointer 205 in response to the calculated coordinates.

FIG. 4(c) exemplifies a case where a user moves the remote control device 200 away from the display 180 while pressing a specific button in the remote control device 200. By this, the selection area in the display 180 corresponding to the pointer 205 can be zoomed in and displayed in an enlarged manner.

Conversely, when the user moves the remote control device 200 closer to the display 180, the selection area in the display 180 corresponding to the pointer 205 can be zoomed out and displayed in a reduced manner.

Meanwhile, when the remote control device 200 moves away from the display 180, the selection area can be zoomed out, and when the remote control device 200 moves closer to the display 180, the selection area can be zoomed in.

In addition, when a specific button in the remote control device 200 is pressed, the recognition of up, down, left, and right movements can be excluded. That is, when the remote control device 200 moves away from or closer to the display 180, the up, down, left, and right movements can be recognized only, and only the forward and backward movements can be recognized. When a specific button in the remote control device 200 is not pressed, only the pointer 205 moves according to the up, down, left, and right movements of the remote control device 200.

Meanwhile, the moving speed or moving direction of the pointer 205 may correspond to the moving speed or moving direction of the remote control device 200.

Meanwhile, the pointer in this specification refers to an object displayed on the display 180 in response to the operation of the remote control device 200. Therefore, in addition to the arrow shape shown in the drawing, the pointer 205 may be an object of various shapes, for example, a concept including a point, a cursor, a prompt, a thick outline, etc. In addition, the pointer 205 may be displayed corresponding to one point of the horizontal and vertical axes on the display 180, and may also be displayed corresponding to multiple points such as a line or a surface.

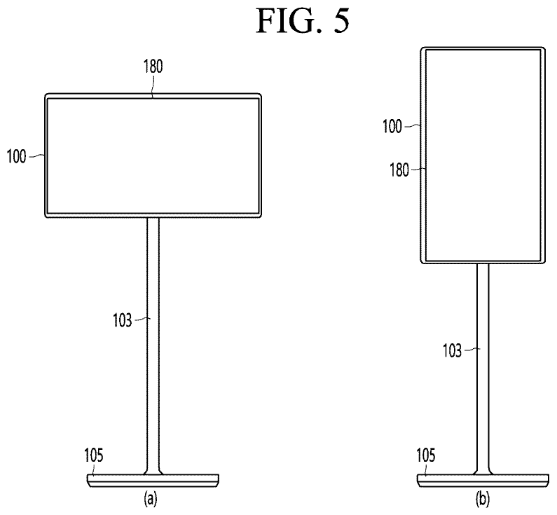

FIG. 5(a) and FIG. 5(b) are drawings for explaining the horizontal mode and the vertical mode of a stand-type display device according to an embodiment of the present disclosure.

Referring to FIG. 5(a) and FIG. 5(b), a stand-type display device 100 is illustrated.

A shaft 103 and a stand base 105 may be connected to the display device 100.

The shaft 103 may connect the display device 100 and the stand base 105. The shaft 103 may extend vertically.

The lower end of the shaft 103 may be connected to the edge of the stand base 105.

The lower end of the shaft 103 may be rotatably connected to the periphery of the stand base 105.

The display device 100 and the shaft 103 can rotate around a vertical axis relative to the stand base 105.

The upper portion of the shaft 103 can be connected to the rear of the display device 100.

The stand base 105 can serve to support the display device 100.

The display device 100 can be configured to include the shaft 103 and the stand base 105.

The display device 100 can rotate around a point where the upper portion of the shaft 103 and the rear of the display 180 meet.

FIG. 5(a) illustrates that the display 180 operates in a landscape mode in which the horizontal length is greater than the vertical length, and FIG. 5(b) illustrates that the display 180 operates in a landscape mode in which the vertical length is greater than the horizontal length.

The user can hold and move the stand-type display device. That is, unlike fixed devices, the stand-type display device 100 has improved mobility, so the user is not restricted by the placement location.

Hereinafter, various embodiments will be described for providing an input list through a screen in the display device 100. Except for necessary cases, parts that overlap with the aforementioned FIGS. 1 to 5 and the corresponding descriptions among the related contents will refer to the aforementioned contents and the duplicate description will be omitted. For example, the description related to the display device 100 and the remote control device 200 (e.g., a remote control) may refer to at least one description of FIGS. 1 to 5.

The present disclosure relates to an operation of providing an input list (or input port list) on a screen of a display device 100 according to an input or condition.

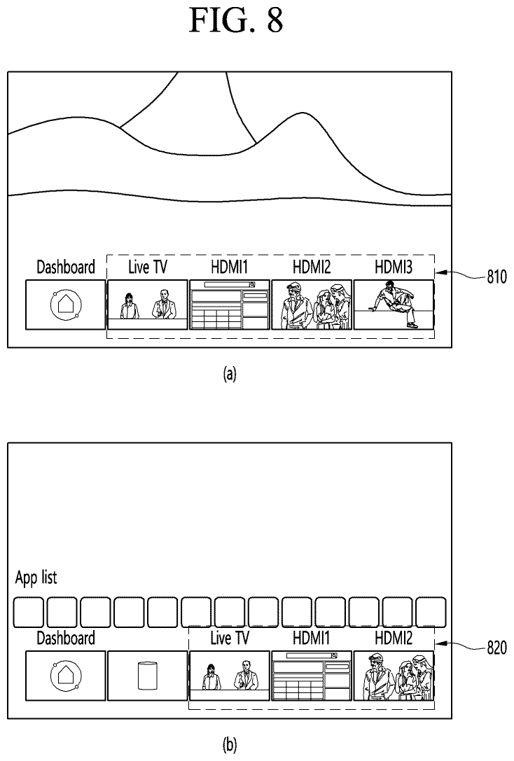

The input list may include an area allocated for each input as illustrated in FIG. 8 described below. According to an embodiment, data received through an input mapped to at least one area among the areas included in the input list determined according to a predefined order may be controlled to be reproduced.

According to an embodiment, the input list may be controlled to reproduce data received through an input mapped to at least one area among the areas included in the input list according to a predefined order through at least one view screen area of a full screen or multi-view mode.

In the input list described in the present disclosure below, even if there is no separate description, receiving video data through a tuner 130 or 131 may be named Live TV and included as one input (input port). Accordingly, the input list may include live TV and at least one external input (for example, input via an HDMI port).

In the present disclosure, when it is described by simply naming it as ‘input’, it may mean including not only an external input via an input port provided in the display device 100 but also an internal input, that is, an input via a tuner 130 or 131. Meanwhile, when it is described by naming it as ‘input port’ in the present disclosure, it may only indicate an external input, but it is not necessarily limited thereto.

Meanwhile, at least one external input may be connected to an external device via the input port, and the input list may include only input ports that are connected to all input ports or devices and are activated because the power of the device is turned on, or may exclude inactive input ports that are not connected to the input port or whose power is turned off. However, the present disclosure is not limited thereto.

For example, in addition to the input port provided in the tuner 130 or 131 or the display device 100, a wirelessly connectable device may also be included in the input list according to the present disclosure and provided through the screen.

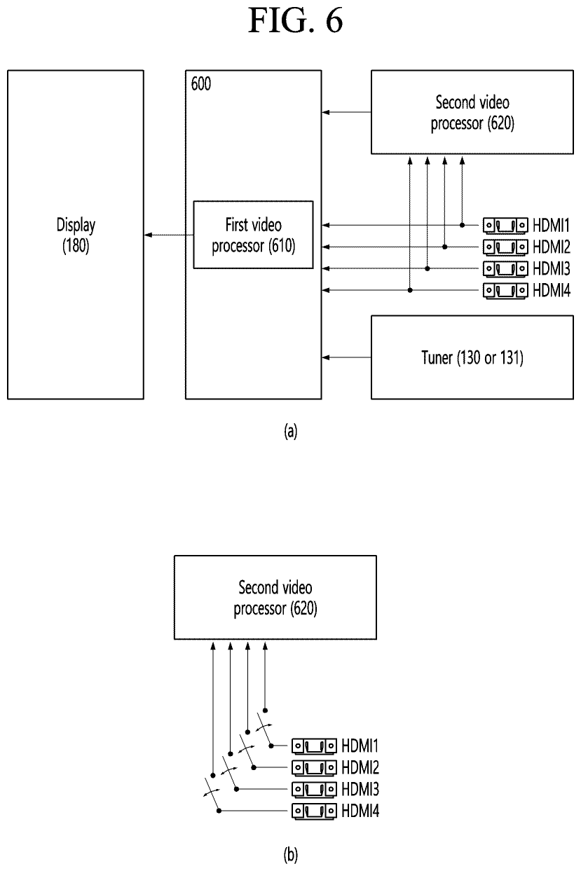

FIG. 6(a) is a block diagram of a display device 100 according to another embodiment of the present disclosure, and FIG. 6(b) is a block diagram of another configuration between the second video processor 620 and the input port in FIG. 6(a).

The display device 100 may be connected to an external device by wire by having at least one input port, and may also be connected to at least one external device by wireless.

In the present disclosure, for the convenience of explanation, input through an input port is described using HDMI input as an example, but is not limited thereto.

In FIG. 6(a) and 6(b), four input ports (HDMI1-HDMI4) are illustrated, but the number of input ports is not limited to four.

Referring to FIG. 6(a) and 6(b), the display device 100 and an external device can be connected to exchange data through the HDMI connection supported by each input port.

The display device 100 may include a memory and a processor. The processor may include a processing unit 600. According to an embodiment, the processor may also include a second video processor 620.

Referring to FIG. 6(a), the processing unit 600 may include a first video processor 610 to process data received through an internal input, i.e., a tuner 130 or 131, and output the data through the display 180. The tuner illustrated in FIG. 6(a) may have the same configuration as the tuner 130 or 131 of FIG. 1.

The processing unit 600 may receive data from an external device through one external input, i.e., an input port, process the received data, and output it through the display 180.

In the present disclosure, the data received through each input may include video data, still image data, audio data, web page data, etc., but for convenience, video data will be described as an example.

In the present disclosure, ‘provision’ may mean any one of the reproduction of video data, provision of a web service, and execution of a web application, or the operation of the display device 100 for that. In addition, ‘provision’ may mean that the result of the above-described operation is output through the screen.

The processing unit 600 may be implemented in the form of a SoC (System on Chip) and may correspond to the controller 170 of FIG. 1, but is not limited thereto. According to an embodiment, the processing unit 600 may be implemented by being separated into multiple modules.

Taking FIG. 6(a) as an example, the display device 100 may be configured to include a first video processor 610 and a second video processor 620 provided in the processing unit. According to an embodiment, the second video processor 620 may also be included in the processing unit 600. According to another embodiment, the first video processor 610 may be provided outside the processing unit 600 like the second video processor 620.

One video processor may process video data received through at least one input. When a plurality of video processors is included in the display device 100, each video processor may be allocated exclusively for internal input (tuner) and external input (input port). Accordingly, the display device 100 may process and provide multiple video data simultaneously.

In FIG. 6(a), the display device 100 is equipped with two video processors 610, 620, which are respectively allocated for the tuner 130 or 131 and one input port, and may simultaneously process and provide video data received through each input. At this time, if one video processor is not allocated for the tuner 130 or 131, the corresponding video processor may be allocated for one input port.

Referring to FIG. 6(a), the second video processor 620 can be sequentially connected to each input port in a predefined order unless a specific input port is requested to be selected by the user, and can process data received through the input port after the connection. The connection can be made only for a set time, and after the time elapses, the remaining input(s) can be connected in a manner of being connected to the next priority input port.

In the present disclosure, the first video processor 610 is provided in the processing unit 600, and the second processor 620 is provided in addition to the processing unit 600, but is not limited thereto.

Referring to FIG. 6(b), the second video processor 620 can switch the input ports sequentially. For example, if there is one input port or one input port is currently activated among multiple input ports, the second video processor 620 can process data received through the corresponding input port at 60 frames/s. On the other hand, if there are multiple activated input ports (for example, four), the second video processor 620 can process signals received through each input port at a speed of 15 frames/s by switching continuously. In the latter case, if the second video processor 620 can process 60 frames per second, for example, it can process four inputs at 15 frames each by switching four times per second, and the display device 100 can continuously perform switching processing by opening and closing the switch illustrated in FIG. 6(b) for the four input ports, thereby providing data for the four input ports as if they were played back simultaneously. However, the present disclosure is not limited to the above-mentioned numerical values.

According to another embodiment, the second video processor may be allocated as many as the number of input ports.

In other words, the number of video processors in the display device 100 may be equal to or less than the number of input ports, but is not limited thereto.

Referring again to FIG. 6(a), the first video processor 610 may be built into the processing unit 600, and the second processor 620 may be provided outside the processing unit 600.

The first video processor 610 may process video data received through one input (either exclusively for internal input or allocated for any one external input), and the second video processor 620 may process data received through an input other than the external input or the input allocated to the first video processor 610 (which may also include a tuner).

When the first video processor 610 is allocated to process video data received through the tuner 130 or 131, the second video processor 620 may be allocated to process video data received through any one input port (one of HDMI1 to HDMI4) at the same time or at different times.

Alternatively, if the first video processor 610 is allocated to process video data received through one input port (e.g., HDMI1), the second video processor 620 may be allocated to process video data received through another input port (one of HDMI2 to HDMI4) simultaneously or at different times.

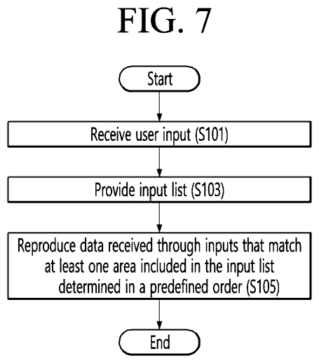

FIG. 7 is a flowchart illustrating an operation method of a display device 100 according to an embodiment of the present disclosure.

FIG. 8 is a diagram illustrating a user interface related to the operation of the display device 100 according to FIG. 7.

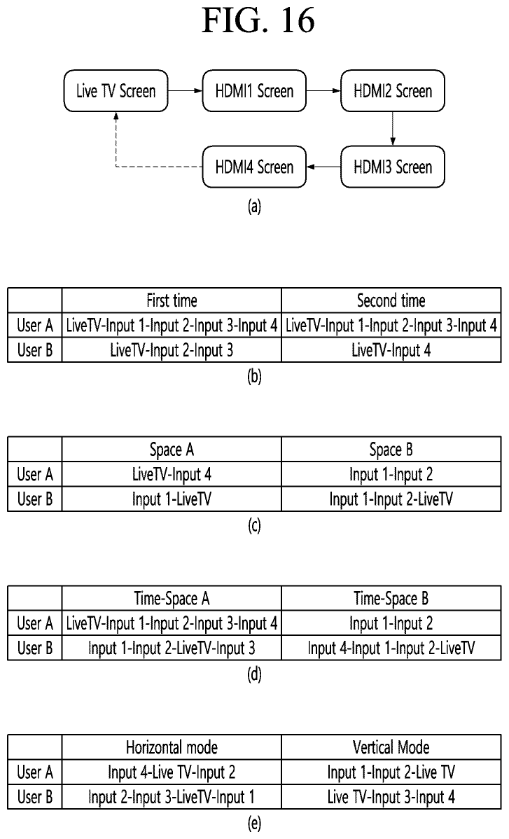

FIG. 16 is a diagram illustrating an input port corresponding video data processing operation in the display device 100 according to an embodiment of the present disclosure.

Referring to FIG. 7, the display device 100 (or processor) may receive a user input (S101).

The display device 100 can provide an input list (S103).

The display device 100 can reproduce (or provide) data received through an input that matches (or maps) at least one area included in the input list determined according to a predefined order (S105).

In step S101, the user input can be received through the remote control device 200.

According to an embodiment, the user input in step S101 can be received through a touch input through a mobile terminal (smartphone, wearable device, etc.) that is connected to the display device 100 or has a remote control application installed, a voice input through an AI speaker, a gesture or biometric input through an image sensor installed on the display device 100 or a predetermined space, etc.

According to another embodiment, the user input can be received in a form in which the above-mentioned methods are appropriately combined.

In step S103, the display device 100 may provide an input list based on the user input received in step S101, but is not necessarily limited thereto.

According to an embodiment, the display device 100 may configure and provide (or output) the input list of step S103 even when the user input is not received through step S101 if a predetermined condition is satisfied.

The predetermined condition may be determined and automatically set based on, for example, a user, time, space, and content provided by the display device 100 or a combination thereof, and the set condition content may be provided through the screen for the convenience of the user.

As a condition, the user may be identified by referring to at least one method among login information, an image captured by an image sensor, password input, etc.

As a condition, for example, when a predefined specific time is reached, the input list may be configured to provide the convenience of the user even without a separate input from the user.

As a condition, if a display device 100 such as FIG. 5 is movable and entry/release into a specific space is identified accordingly, an input list can be configured to provide convenience for the user even without a separate input from the user.

Other conditions can also be explained in the same way. With regard to setting, storing, etc. of these conditions, FIG. 16 can be referred to. For example, FIG. 16(a) can be viewed as a default setting, and a look-up table (LUT) or a mapping table such as FIG. 16(b) to 16(d) can be created and stored in a personalized or customized manner.

FIG. 16(a) can represent a basic playback order (Live TV screen—HDMI1 screen—HDMI2 screen—HDMI3 screen—HDMI4 screen—Live TV screen). However, the present disclosure is not limited thereto. According to an embodiment, the display device 100 may process the channels of the first Live TV screen and the last Live TV screen to be different from each other, and may recommend channels in which the properties or genres of the contents provided by each channel or the respective channels are related to each other, but is not limited thereto.

In FIG. 16(b), a table considering the user and time as conditions is exemplified, in FIG. 16(c), a table considering the user and space as conditions is exemplified, in FIG. 16(d), a table considering the user, time, and space as conditions is exemplified, and in FIG. 16(e), a table considering the horizontal mode or the vertical mode as conditions in the case where the display device 100 can operate in the horizontal mode or the vertical mode as in FIG. 5 is exemplified.

The table illustrated in FIG. 16 may be stored in the built-in DB of the display device 100 or in a DB (for example, in the form of a cloud) connected to a server (not shown).

Referring to FIG. 7, a user interface provided on a screen related to the operation of the display device 100 of FIG. 8 is described.

FIG. 8(a) illustrates an input list 810 provided on a home dashboard, and FIG. 8(b) illustrates an input list 820 provided when a home dashboard and an application list are provided. However, the present disclosure is not limited to the configuration of a user interface including the input list illustrated in FIG. 8.

FIG. 8 illustrates an embodiment in which an input list (810, 820) is provided on a home dashboard for convenience, but the input list may be provided on an application list or may be provided through an input list that is created separately rather than the home dashboard or the application list.

The input list 810 illustrated in FIG. 8(a) provides areas for providing information on all input ports (Live TV, HDMI1, HDMI2, and HDMI3) equipped in the display device 100, and data received through a device connected to the corresponding input port may be provided in each area.

In the input list of FIG. 8, areas for providing information on only some of the input ports (Live TV, HDMI1, and HDMI2) equipped in the display device 100 may be provided, and data received through a device connected to the corresponding input port may be provided in each area. In the case of FIG. 8(b), the input port (HDMI3) may be excluded from the input list because it is in an inactive state, such as when there is no connected device or the connected device is powered off.

According to an embodiment, if there are sufficient resources, that is, if the number of video processors is greater than or equal to the number of input ports provided in the display device 100, video data received through the corresponding input ports may be simultaneously played in each area included in the input list.

According to an embodiment, even if there are sufficient resources as described above, the display device 100 may control not to activate all areas included in the input list, that is, to simultaneously play video data received through the corresponding input ports, but to activate only some area(s) and to sequentially play the remaining areas in a predefined order thereafter.

The display device 100 may control to provide a still image of data to be received and played through an input mapped to the corresponding area or a representative image representing the corresponding input for an area other than at least one area determined according to a predefined order.

According to an embodiment, when resources are insufficient, that is, when the number of video processors is less than the number of input ports provided in the display device 100, only some areas among all areas included in the input list may be selected, and in the some areas, video data received through the mapped input may be played, and in the remaining areas, a blank screen (or black screen) or a still screen image (or still image) of video data to be provided later may be provided.

According to an embodiment, when the display device 100 provides data received through input mapped to the next area according to, for example, satisfaction of the first condition described below, for the area of the previous order, at least one of the first frame of the data provided, the last frame, the representative thumbnail image of the corresponding data, the representative thumbnail image representing the input mapped to the corresponding area, and the still image for the scene in which the user input was made for the corresponding area may be controlled to be output.

In the present disclosure, only some of the areas are activated, not all areas included in the input list, but if the display device 100 has sufficient resources, a pre-coding operation may be performed on the video data of the areas to be played back later. Through this, it is possible to prevent the occurrence of situations in advance due to network conditions or other problems occurring later, or to quickly identify problems such as network conditions with the corresponding input port.

The input list illustrated in FIG. 8(a) and 8(b) allocates an area corresponding to at least one input port, and each area reproduces and provides video data received through at least one input port as described below, and each area may be related to the playback order of the video data received through the corresponding input port. Taking FIG. 8(a) as an example, four areas are allocated in the input list corresponding to each input port, i.e., Live TV, HDMI1, HDMI2, and HDMI3 input ports, and video data received through HDMI1, HDMI3, and HDMI3 input ports in sequence from Live TV can be played or vice versa.

In relation to this, when a user performs an operation such as touch & drag, voice input, or gesture through a remote control device 200, an artificial intelligence speaker, or a linked smartphone, the display device 100 can control the desired area to be selected and moved, deleted, or added in response, and can also control the playback of a specific input port to be excluded, paused, stopped, or played again.

In the case where the display device 100 in FIG. 6 is equipped with a number of video processors corresponding to the input ports, each area included in the input list in FIG. 8 can provide video data received through the corresponding input port.

When video data is played in an area corresponding to two or more input ports included in the input list, all audio data may be muted or only audio data for video data received and played through an input port with the highest priority may be controlled to be output.

According to an embodiment, when video data received through at least one input port included in the input list is being provided, output control of audio data may be determined according to content being provided through the main screen of the display device 100.

In the input lists of FIG. 8(a) and 8(b), input ports corresponding to content currently being provided through the main screen of the display device 100 or content whose playback has been stopped may be excluded.

According to another embodiment, in the input list of FIG. 8(a) and 8(b), if an input port corresponding to content currently being provided or stopped playing through the main screen of the display device 100 corresponds to a tuner, and if the display device 100 is equipped with multiple tuners, video data of a different medium or a different channel from the content may be provided without being excluded.

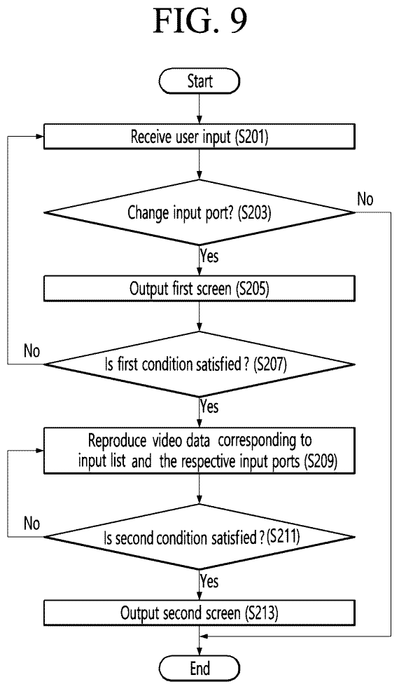

FIG. 9 is a flowchart illustrating an operating method of a display device 100 according to another embodiment of the present disclosure.

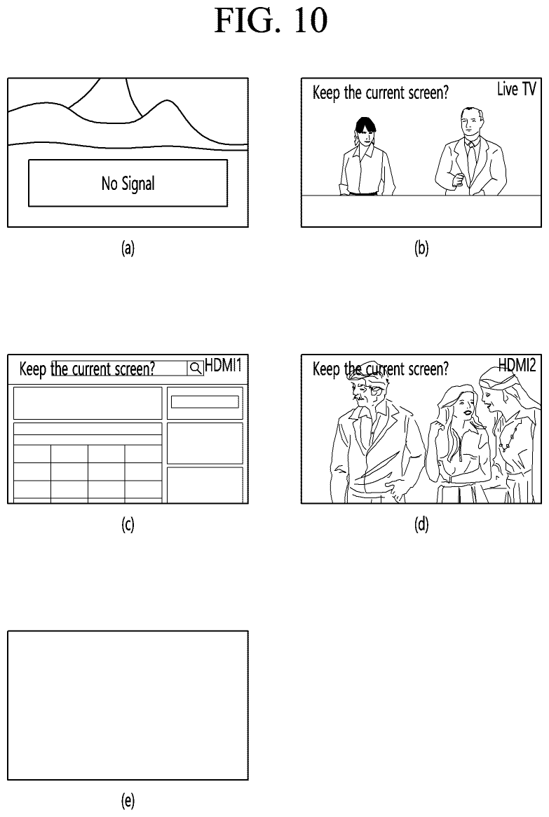

FIG. 10 is a diagram illustrating a user interface related to the operation of the display device 100 according to FIG. 9.

Referring to FIG. 9, the display device 100 can receive a user input (S201).

The display device 100 can determine whether the user input is a request to change an input port (S203).

If the result of the judgment in step S203 is a request for changing the input port, the display device 100 can output the first screen (S205).

The display device 100 can determine whether the first condition is satisfied (S207).

If the result of the judgment in step S207 is that the first condition is satisfied, the display device 100 can provide video data received through the input port corresponding to the input list and at least one area included in the input list on the corresponding area (S209).

The display device 100 can determine whether the second condition is satisfied (S211).

If the result of the judgment in step S211 is that the second condition is satisfied, the display device 100 can output the second screen (S213).

Referring to FIG. 9, FIG. 10(b) to 10(d) may be screens in which video data received through each input port included in the input list is played. FIG. 10(b) to (d) may be screens that are played sequentially.

Meanwhile, FIG. 10(a) may be a first screen provided like step S205 due to a user input received in step S201 of FIG. 9 being an input list request or a missed input unrelated to the content being output through the display 180. According to one embodiment, the first screen of FIG. 9 may be a ‘No Signal’ screen. According to another embodiment, the first screen may continue the previously provided screen, but in response to the user input, information called ‘No Signal’ may be provided in a pop-up form or the like in an area of the screen.

FIG. 10(b) may provide a Live TV screen as a first priority input port included in the input list after the screen of FIG. 10(a) is provided.

The display device 100 may control to provide data received through an input in which video data is mapped to the next area in the predefined order among the areas included in the input list when the first condition is satisfied.

FIG. 10(b) may be provided when the first condition is satisfied. Here, the first condition may indicate a predefined time, and the predefined time may be set to 3 seconds, 5 seconds, 10 seconds, 30 seconds, 1 minute, etc., and may be arbitrarily changed.

FIG. 10(c) may provide an HDMI1 screen as a second priority input port included in the input list after the screen of FIG. 10(b) is provided.

FIG. 10(d) may provide an HDMI2 screen as a third-priority input port included in the input list after the provision of the screen of FIG. 10(c).

FIG. 10(e) may be a second screen provided like step S213 provided after the provision of the screen of FIG. 10(d). According to one embodiment, the second screen may be a blank screen or a black screen. According to another embodiment, the second screen may be the same as the screen shown in FIG. 10(a) or may be any one of the screens of FIG. 10(b) to 10(d).

Meanwhile, the second screen of FIG. 10(e) may be provided when the second condition is satisfied. Here, the second condition may indicate a case where there is no input port that is not played among the input ports included in the input list.

FIG. 10(a) to 10(e) can be viewed as screens sequentially provided on the screen of the display device 100 according to the order of time. In FIG. 10, for convenience, the screen received through each input port is provided as a full screen, but it is not limited thereto.

The display device 100 provides video data received through the individual input ports shown in FIG. 10(b) to 10(d) through the screen, and can provide various information in one area of the screen. The first information may be input port identifier information for receiving video data output through the corresponding screen. The second information may be a screen asking whether to continue to maintain the video data screen of the current input port. The third information may be input port identifier information of the screen to be switched next. The various information described above may be provided in the form of a pop-up, etc. The display device 100 may immediately switch to the screen of the desired input port, maintain the screen of the corresponding input port, or return to the previous playback screen, instead of sequential playback, depending on the user's selection.

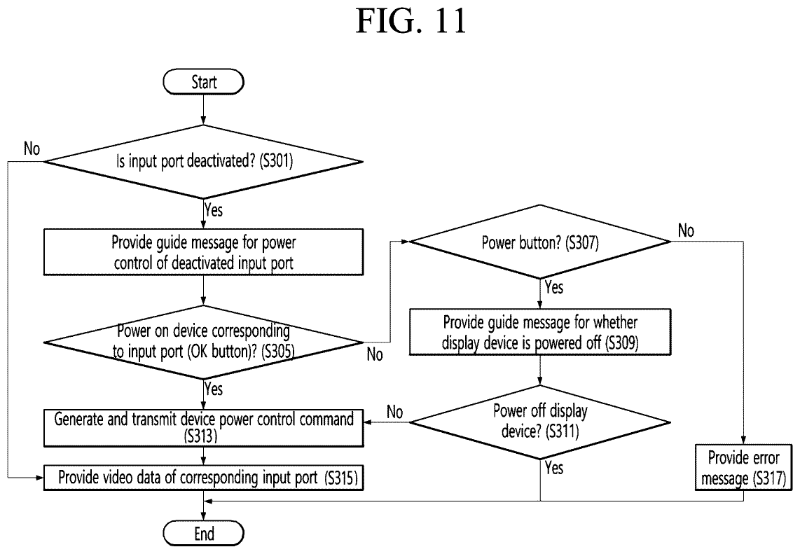

FIG. 11 is a flowchart illustrating an operation method of a display device 100 according to another embodiment of the present disclosure.

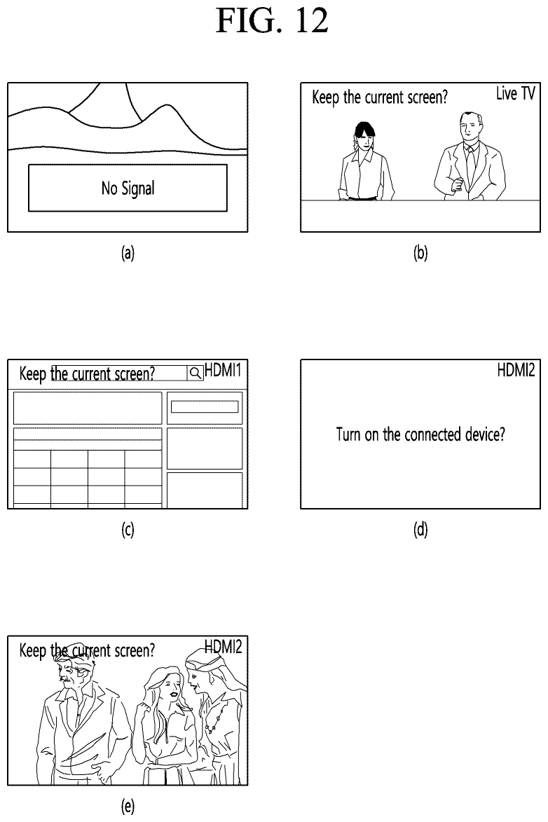

FIG. 12 is a diagram illustrating a user interface related to the operation of the display device 100 according to FIG. 11.

FIGS. 11 and 12 describe a processing operation of the display device 100 in particular when at least one input port among input ports included in the input list is deactivated.

In the present disclosure, deactivation of an input port may refer to at least one of the following cases: when there is no device connected to the corresponding input port, when there is a device connected to the corresponding input port but the device is powered off or cannot normally receive video data from the corresponding device due to other errors, or when video data that has been normally received cannot be decoded or processed due to causes such as a codec.

Referring to FIG. 11, the display device 100 can determine whether the input port is in an inactive state (S301).

If the input port is in an inactive state as a result of the determination in step S301, the display device 100 can provide a guide message for power control of the inactive input port (S303). Here, the guide message can be provided as in FIG. 10(d), but is not limited thereto.

After providing the guide message in step S303, the display device 100 can determine whether a power-on request input of the inactive input port corresponding device has been received by the user (S305). At this time, the power-on request of the inactive input port corresponding device can be made, for example, by pressing the ‘okay’ button of the remote control device 200, but is not limited thereto.

If the display device 100 is not a power-on request for an inactive input port-compatible device as a result of the judgment in step S305, for example, if a signal is received through the remote control device 200 in response to pressing a button other than the ‘okay’ button, the display device 100 can determine whether the input is an input in response to pressing the power button (S307).

If the display device 100 is not an input in response to pressing the power button as a result of the judgment in step S307 in response to pressing the power button, the display device 100 can provide an error message such as ‘You pressed the wrong button’ (S317).

On the other hand, if the display device 100 is an input in response to pressing the power button as a result of the judgment in step S307 in response to pressing the power button, the display device 100 can provide a related guide message to identify whether the input is a power-off input to turn off the power of the display device or an input in response to turning on the power of the inactive input port-compatible device of the aforementioned step S305 (S309).

After providing the guide message in step S309, the display device 100 can determine whether the user's input through the remote control device 200 requests power off of the display device 100 (S311).

If the user's input through the remote control device 200 is a power off request for the display device 100 as a result of the determination in step S311, the display device 100 can turn off the power of the display device 100.

On the other hand, if the user's input through the remote control device 200 is not a power off request for the display device 100 as a result of the determination in step S311, i.e., if it is an input for powering on a device corresponding to an inactive input port in step S305, the display device 100 can generate a device power control command and transmit it to the corresponding device (S313). The same applies to the case where the ‘okay’ button is input in the aforementioned step S305.

The display device 100 can provide the corresponding input port video data (S315) if the power of the corresponding device is turned on after step S313. The display device 100 can also determine whether the power of the corresponding device is turned on, for example, by whether data is received through the corresponding input port.

The display device 100 can perform the operations corresponding to FIG. 12(a) to 12(c), as shown in FIG. 10(a) to 10(c), and can refer to FIG. 9 as needed. That is, FIG. 11 can be premised on at least one or more steps shown in FIG. 9.

If the result of the determination in step S301 illustrates that at least one input port is in an inactive state, the display device 100 can provide a screen like (d) of FIG. 12 and a guide message of step S303.

The display device 100 may provide a screen as shown in FIG. 12(d) according to the determination result of step S301, and if the inactive input port becomes active through at least one process among steps S305 to S315, the display device 100 may receive video data from device connected to the corresponding input port and provide it as shown in FIG. 12(e).

According to an embodiment, the display device 100 may determine whether the inactive state of the corresponding input port is due to the absence of a connected external device by generating and transmitting a device power control command of step S313 between steps S303 and S305, since the inactive input port may not be a case where an external device is connected but powered off, but rather a case where an external device is not connected at all. In this case, a simple version of the command may be generated and transmitted compared to the device power control command of step S313, simply to determine the presence or absence of an external device connected to the corresponding input port.

In the processes of FIG. 12(d) and 12(e), the display device 100 may use a predetermined protocol to control the power of the device connected to the disabled input port. In the present disclosure, HDMI-CEC (Consumer Electronics Control) is used as an example of the device power control protocol, but is not limited thereto.

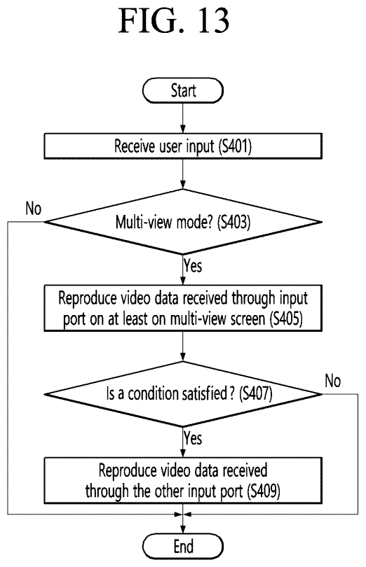

FIG. 13 is a flowchart illustrating an operation method of a display device 100 according to another embodiment of the present disclosure.

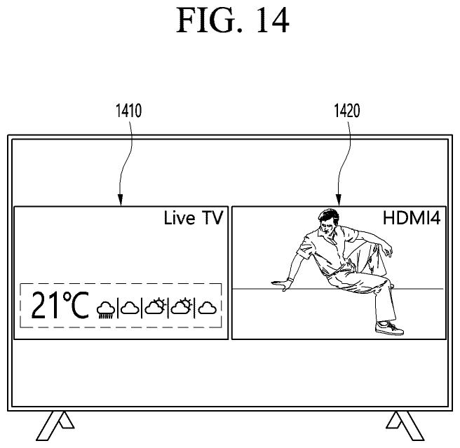

FIG. 14 is a diagram illustrating a user interface related to the operation of the display device 100 according to FIG. 13.

FIG. 13 may particularly illustrate a processing operation according to the present disclosure when the display device 100 supports a multi-view mode. The multi-view mode may indicate a mode that provides different contents through at least two individual screen areas on one screen, as in FIG. 14(a).

The display device 100 may control data received through an input mapped to at least one area among the areas included in the input list according to a predefined order to be played through at least one view screen area of the full screen or multi-view mode.

When a user input is received (S401), the display device 100 may determine the multi-view mode (S403).

If the display device 100 is in the multi-view mode, the display device 100 may provide video data received through each input port to each multi-view screen area (S405).

The display device 100 may provide video data of the input port in the multi-view mode through step S405, but may determine whether a condition is satisfied (S407).

If the condition of the judgment result of step S407 is satisfied, the display device 100 can provide video data corresponding to another input port (S409).

If at least one of the following applies: if the current playback mode of the display device 100 is a multi-view mode; if the multi-view mode is requested through a remote control device 200, etc.; if there are multiple viewers currently watching the display device 100; if it is determined that the multi-view mode is preferred based on the history information of a user who has logged into the display device 100; the display device 100 can perform the operation after step S405, i.e., provide an input list according to the present disclosure in the multi-view mode.

Referring to FIG. 14, the display device 100 can output video data of the first input port (e.g., Live TV) to the first screen area 1410 and output video data of the second input port (e.g., HDMI4) to the second screen area 1420.

The display device 100 can individually perform each screen area depending on whether the condition of step S407 is satisfied. That is, the display device 100 can individually perform the operation after step S407 for the first screen area 1410 and the operation after step S407 for the second screen area 1420. Meanwhile, the individual operation performances can be performed simultaneously or sequentially. Therefore, referring to FIG. 14, as a result of the judgment in step S407, the video data of the first input port is continuously output in the first screen area 1410, but the video data of the second input port in the second screen area 1420 may be changed to the video data of the third input port.

The condition in step S407 may correspond to either the first condition or the second condition described in FIG. 9 described above, but is not limited thereto.

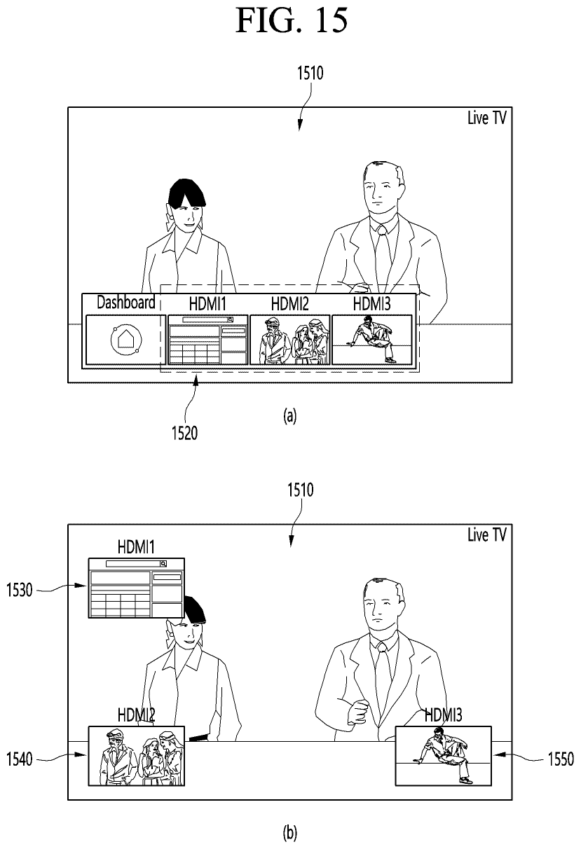

FIG. 15 is a drawing illustrating another user interface related to the operation of the display device 100 according to the present disclosure.

As illustrated in FIG. 10 and FIG. 12, the video data received through each input port in the display device 100 may be provided in full screen or in multi-view mode as illustrated in FIG. 14.

Referring to FIG. 15, the display device 100 can provide video data received through one input port as a full screen, and can provide video data received through the remaining input ports through one area within the screen simultaneously.

Referring to FIG. 15(a), the display device 100 can automatically execute the dashboard 1520 and provide video data received through the remaining input ports to items or areas of the dashboard 1520.

Referring to FIG. 15(b), the display device 100 can allocate a predetermined area within the screen as many as the number of remaining input ports, similar to FIG. 15(a) described above, and provide video data received through the remaining input ports to each allocated area 1530, 1540, 1550.

The display device 100 may, when a predetermined condition is satisfied, move the screen of the corresponding input port provided through the entire screen to one area of the dashboard 1520 shown in FIG. 15(a) and continue to provide it, or move it to one of the allocated areas (1530 to 1550) shown in FIG. 15(b) and continue to provide it. In this case, the video data of the input port that was being provided to one area of the corresponding dashboard 1520 or the allocated predetermined area may be provided through the entire screen.

According to an embodiment, referring to FIG. 15(a) and 15(b), if there is no additional input from the user, the display device 100 sequentially provides video data received through the corresponding input port through the entire screen according to conditions (e.g., preset time units) and settings (playback order, etc.), and at each change, the video data of the input port previously provided may be moved and output on the dashboard 1520 shown in FIG. 15(a) or the allocation area 1530, 1540, 1550 shown in FIG. 15(b) as described above. Meanwhile, the video data of the input port that has been played may no longer be played and may be replaced with a still image captured or acquired from the previously played video data. Through this, the user may recognize that the data of the corresponding input port has already been provided through the entire screen.

According to an embodiment, the display device 100 shown in FIG. 5 may also be moved to a desired space by the user. The display device 100 may provide a customized input list based on the space in which the display device 100 is currently located, as requested by the user or based on at least one of FIG. 16(c) to 16(e), and may provide the input list by configuring it differently based on the recognized space (entry or exit may also be considered).

According to another embodiment, the display device 100 may provide the input list based on time information, and may provide the input list by configuring it differently based on the current time, as in FIG. 16(b) or 16(d).

According to another embodiment, the display device 100 may provide the input list according to the user, and may provide the input list by configuring it differently based on the identified user, as in FIG. 16(b) or 16(d).

According to another embodiment, the display device 100 may provide the input list according to the environmental information, and may provide the input list by configuring it differently based on the analysis result of the detected environmental information. The environmental information may indicate weather, temperature, humidity, illuminance, etc.

According to another embodiment, the display device 100 may provide an input list according to IoT (Internet of Things) information, and may provide the input list by configuring it differently based on the IoT information. The IoT information may indicate whether the display device 100 is paired, identification information about the paired device, control information, etc.

According to another embodiment, the display device 100 may provide an IoT device list according to the method described in the present disclosure instead of the input list according to the IoT information.

According to another embodiment, referring again to FIG. 10(e), if the second condition of step S211 of FIG. 9 is satisfied, unlike the above, instead of or together with the provision of the second screen, it may be determined whether a device capable of wireless connection is searched in the vicinity. The display device 100 may provide, in addition to the input list, a screen of FIG. 10(e) or after the screen of FIG. 10(d), if there is a wireless connection request or a device capable of wireless connection around the search result.

According to another embodiment, the display device 100, for example, when the second condition of step S211 of FIG. 9 is satisfied, may determine one input port by referring to the user's actions for each input port included in the input list, instead of the screen of FIG. 10(e) as described above, and provide video data of the corresponding input port. The user's actions may indicate, for example, at least one of whether or not the user made an input operation through the remote control device 200 while providing the screen of the corresponding input port, the number of input operations, the input operation time, a search request related to the device or video data connected to the corresponding input port, etc.

According to another embodiment, the display device 100 may provide video data of a determined input port instead of the screen of FIG. 10(e) by referring to other data even when there is no user action in the above-described embodiment. The other data may indicate at least one of the following: the video data playback time or viewing time of the corresponding input port, whether the video data of the corresponding input port has been provided beyond the time allocated to each input port, and whether a control operation for the video data of the corresponding input port (playback stop, playback resume, etc.) is performed.

According to another embodiment, the display device 100 may select and provide video data of an input port corresponding to the highest priority based on at least one of the input port priority, device priority, content priority, etc. instead of the screen of FIG. 10(e). This may indicate a processing operation even after the second condition of step S211 of FIG. 9 is satisfied, if no selection input is received from the user.

In relation to various embodiments of the present disclosure, at least some of the sequences or steps illustrated in the flowcharts of FIGS. 7, 9, 11, and 13 may be performed simultaneously or differently from the illustrated ones.

According to one embodiment of the present disclosure, the above-described method can be implemented as a processor-readable code on a medium in which a program is recorded. Examples of the processor-readable medium include ROM, RAM, CD-ROM, magnetic tape, floppy disk, optical data storage device, etc.

The display device described above is not limited to the configuration and method of the embodiments described above, and the embodiments may be configured by selectively combining all or some of the embodiments so that various modifications can be made.

### Industrial Applicability

The display device according to the present disclosure can provide an input list for recognition or identification convenience for various inputs serviceable by the display device, including inactive external inputs, thereby improving the convenience of use of the display device, and thus has industrial applicability.

What is claimed is:

1. A display device comprising:
a display;
a memory; and
a processor configured to transmit and receive data to and from the memory,
wherein the processor is configured to configure an input list including areas allocated for the respective inputs and output the input list on a screen, and
wherein the processor is configured to control data received through an input mapped to at least one area among the areas included in the input list determined according to a predefined order to be reproduced.

2. The display device of claim 1, wherein the processor is configured to control, for areas other than the at least one area determined according to the predefined order, a still image of data to be received and reproduced through an input mapped to the corresponding area or a representative image representing the corresponding input to be provided.

3. The display device of claim 2, wherein the processor is configured to receive a user input from a connected terminal.

4. The display device of claim 3, wherein the terminal includes at least one of a remote control, an artificial intelligence speaker, and a mobile device.

5. The display device of claim 4, wherein the processor is configured to control the input list to configured when the user input is an input list request or an erroneous input unrelated to the content being output through the display.

6. The display device of claim 5, wherein the processor is configured to determine whether a first condition indicating whether a user input has been received or whether a predefined time has elapsed has been satisfied.

7. The display device of claim 6, wherein the processor is configured to control to provide data received through an input in which video data is mapped to the next area in the predefined order among the areas included in the input list when the first condition has been satisfied.

8. The display device of claim 7, wherein when providing data received through input mapped to the next area according to the satisfaction of the first condition, the processor is configured to control, for the previous order area, at least one of a first frame of data provided, a last frame, a representative thumbnail image of the corresponding data, a representative thumbnail image representing the input mapped to the corresponding area, and a still image for a scene where the user input was made for the corresponding area to be output.

9. The display device of claim 1, wherein the processor is configured to configure the input list so that no area is allocated for a deactivated input.

10. The display device of claim 1, wherein the processor is configured to configure the input list by allocating an area even for a deactivated input, and when it is the turn to provide data to the area for the deactivated input, control to transmit a control signal so that the power of the device connected to the deactivated input is turned on.

11. The display device of claim 10, wherein the processor is configured to control to transmit the control signal using the HDMI-CEC protocol.

12. The display device of claim 8, wherein the processor is configured to determine whether a second condition regarding whether data has been provided in order in all allocated areas is satisfied.

13. The display device of claim 12, wherein when the second condition has been satisfied, the processor is configured to control one of a black screen and a content screen previously provided before the user input to be provided on the screen.

14. A display device comprising:
a display;
a memory; and
a processor configured to transmit and receive data to and from the memory,
wherein the processor is configured to through an input list including areas allocated for the respective inputs,
wherein the processor is configured to control data received through an input mapped to at least one area among the areas included in the input list determined according to a predefined order, through at least one view screen area of a full screen or multi-view mode to be reproduced.

15. A method of controlling an operation of a display device, comprising:
receiving a user input; and
configuring an input list including areas allocated for the respective inputs according to the user input,
wherein:
(a) the input list is included and output within a dashboard menu, and data received through an input mapped to only at least one area according to a predefined order is reproduced, or
(b) data received through an input mapped to at least one area among the areas included in the input list according to a predefined order is reproduced on at least one view screen area of a full screen or multi-view mode.
